(19) United States
(12) Patent Application Publication
(10) Pub. No.: US 2026/0208863 A1
(43) Pub. Date: Jul. 23, 2026

(54) WEARABLE FLIGHT SYSTEM WITH SUPPORT FOR PROPULSION UNITS

(71) Applicant: GRAVITY INDUSTRIES LTD, Salisbury (GB)

(72) Inventor: Richard Browning, Salisbury (GB)

(21) Appl. No.: 19/140,771

(22) PCT Filed: Feb. 22, 2024
(86) PCT No.: PCT/EP2024/054534

§ 371 Date: Jun. 18, 2025

(30) Foreign Application Priority Data
Feb. 23, 2023 (GB) 2302602.4

(51) Int. Cl. B64C 39/02; A45F 3/14; B64D 27/40

(52) U.S. Cl. CPC B64C 39/026; A45F 3/14; B64D 27/406; A45F 2003/142; A45F 2003/146

(57) ABSTRACT

The invention relates to a wearable flight system, that is, an apparatus for enabling an individual to fly. A wearable flight system (10) for a user comprises a right hand propulsion unit (14), a left hand propulsion unit (16), and a body support structure (18) for being worn on the user's body. The wearable flight system (10) further comprises a right support arm (20) extending from the body support structure (18) to the right hand propulsion unit (14) and connected to the body support structure (18) by a right rotational joint (101) comprising a resilient member; and a left support arm (22) extending from the body support structure (18) to the left hand propulsion unit (16) and connected to the body support structure (18) by a left rotational joint (103) comprising a resilient member.

The invention relates to a wearable flight system, that is, an apparatus for enabling an individual to fly. In particular, the invention relates to the provision of support arms that can be used with hand propulsion units and a body support structure.

There have been attempts in the past to enable individuals to fly with only minimal equipment. One example of this is the personal flying equipment described in GB 2559971B1 . This arrangement leaves room for further development.

In particular, the personal flying equipment of the prior art provides excellent freedom of movement and control to the user by virtue of the user's own body being used to direct thrust from the propulsion units. However, such freedom comes with the disadvantage that the user's physicality is relied upon to a large extent, such that the muscular endurance of the user can limit the duration of a flight. Moreover, the technical range of the flight equipment is limited by fuel and/or battery storage, such that an increased range requires an increased load to be carried, which load provides greater physical strain for the user.

Accordingly, there is provided a wearable flight system as defined by the claims.

A wearable flight system for a user comprises: a right hand propulsion unit; a left hand propulsion unit; a body support structure for being worn on the user's body; a right support arm extending from the body support structure to the right hand propulsion unit and connected to the body support structure by a right rotational joint comprising a resilient member; and a left support arm extending from the body support structure to the left hand propulsion unit and connected to the body support structure by a left rotational joint comprising a resilient member.

The left support arm is arranged to engage the left hand propulsion unit. The right support arm is arranged to engage the right hand propulsion unit.

The engagement of the left and right support arms with the corresponding left and right hand propulsion unit is for ensuring that the propulsion unit moves with the support arm as it rotates around the respective rotational joint and for transferring thrust from the propulsion unit to the body support structure via the support arm.

The left and right hand propulsion units need not be permanently fixed to the support arms. Indeed, it is preferable that they are detachable.

Moreover, the left and right hand propulsion units may or may not be locked to the corresponding support arm in a way that prevents separation by relative movement of the propulsion unit along the length of the support arm. For example, in preferred embodiments they are simply engaged by sliding the end of the corresponding support arm (or some protruding member) into a receiver in the left and right hand propulsion unit. Such engagement enables the left and right hand propulsion units and the respective support arms to rotate together about the rotational joint, but enables the user to slide the propulsion units off the end of the support arms when desired (for example, after landing).

The resilient members may extend from the proximal end of the support arm to the body support structure, and can enable rotation of the support arms in multiple planes extending through the longitudinal axis of the proximal end of the support arm. In particular, rotation of the support arms is achieved via bending of the resilient member.

The resilience of each resilient member biases the respective support arm to a neutral position and provides a restoring force when displaced from a neutral position. This can provide a natural assistance to the user when the wearable flight system is worn and used to hold the right and left hand propulsion units in the appropriate position for stable flight.

Preferably, the amount of displacement from the neutral position is limited by the joint. This could be achieved via stops, and/or via the restoring force increasing in response to greater displacement.

The neutral position defines the position that the support arms will rest when not attached to the propulsion units.

Gravity and thrust forces, along with external forces such as those caused by wind resistance may tend to push the right and left hand propulsion units away from the appropriate position for stable flight. The appropriate position may vary depending on the configuration of the propulsion units (including whether a body propulsion unit is provided), and the particular speed desired, and any manoeuvre being attempted. However, the neutral position provides a generally applicable configuration of the parts of the wearable flight system from which the user (and thrust forces etc.) may displace those parts during use.

In contrast, without the support provided by the support arms, the equivalent neutral position would essentially be that the hand propulsion units just hang down by the user's side, with the user and thrust forces displacing them from that position. As such, the use of resilient members in the joints allows flight to be carried out with smaller (and less forceful) displacements from the neutral position.

The resilient members are preferably elastic members (such as a spring) and/or are formed of an elastomeric material (such as rubber, possibly with reinforcement).

The resilient member comprises two connecter portions wherein: a first connector portion is proximal the body support structure; a second connector portion is proximal the right or left support arm. In some embodiments, a neck portion is provided between the connector portions and has a smaller width than the connecter portions to provide a preferable location for bending.

The body support structure has a contact surface for contacting the user when worn (for example, when a harness is provided). In a preferable neutral position, the left and right support arms are held away from the body support structure. That is, they extend generally forwardly with respect to the contact surface. More preferably, they are angled relative to the contact surface. For example, they may be angled downwardly (relative to the orientation when worn).

The contact surface may be cushioned.

Another preferable aspect of the neutral position is that the support arms diverge from one another, such that the distal ends of the support arms are further apart than the proximal ends.

The body support structure preferably comprises left and right extension rigidly extending therefrom to which the left and right support arms are connected by the respective rotational joints. The extensions extend away from the contact surface of the body support structure for positioning the joints below the user's armpits. In this way, the support arms are advantageously between the user's arms and body.

Although it is sufficient for the support arms to pivot only at the point of attachment to the body support structure, in some case it may be preferable to additionally provide some flexion at the elbows.

In such cases, the left and right support arms comprise rigid upper and lower arm members, joined by an elbow joint. The elbow joints preferably comprise a resilient member extending between the upper and lower arm members.

Similar to the resilient members of the rotational joints, the resilient members of the elbow joints provide a restoring force towards a neutral elbow position.

Preferably, the amount of displacement from the neutral elbow position is limited by the joint. This could be achieved via stops, and/or via the restoring force increasing in response to greater displacement.

In some embodiments, one or more of: the support arms; the optional extensions; the optional upper and lower arm members, may be adjustable in length.

Whereas the personal flying equipment of the prior art typically involves three separate propulsion systems, one on each hand, and one on the user's body, the use of the support arms of the present invention can enable the user to fly with just arm propulsion assemblies, without any loss of comfort or control as a result of the additional load carried by each arm.

The right and left rotational joints optionally comprise a mechanism for adjusting a stiffness of the joint. This allows the user to have more support and resistance from the joint, only when desired. This is useful in general flight, or faster flight. Due to the mechanism the user retains the option of enhanced flexibility, at the cost of less support, for segments of flight where improved manoeuvrability is desired.

Preferably, the rotational joints each comprise a rigid sleeve and a resilient member, wherein a portion of the resilient member is retainable within the rigid sleeve. The user may change to a lower stiffness configuration by extending more of the resilient member from the rigid sleeve. Since more of the resilient member is then able to move, the joint will have reduced stiffness as compared with the resilient member being retained within the rigid sleeve This provides an efficient implementation of the mechanism with adjustable stiffness described above with the aforementioned advantages.

Optionally, the rotational joints comprise a rigid sleeve and a resilient member with at least two portions of differing stiffness, wherein the portion with lower stiffness is retainable within the rigid sleeve. The user may change to a lower stiffness configuration by extending the portion with lower stiffness from the rigid sleeve. This provides an efficient implementation of the mechanism with adjustable stiffness described above with the aforementioned advantages.

Optionally, the rotational joints each comprise a biasing member for biasing the portion with the lower stiffness into the rigid sleeve. This ensure that the rotational joints are biased towards a position providing additional support, and that additional flexibility is only present when actively selected by the user.

The resilient member with at least two portions of differing stiffnesses optionally comprises two resilient members with differing stiffnesses attached to each other. Alternatively, the resilient member with at least two portions of differing stiffnesses comprises a single resilient member with varying stiffness along its length.

For a better understanding of the invention, and to show how the same may be put into effect, reference will now be made, by way of example only, to the accompanying drawings in which:

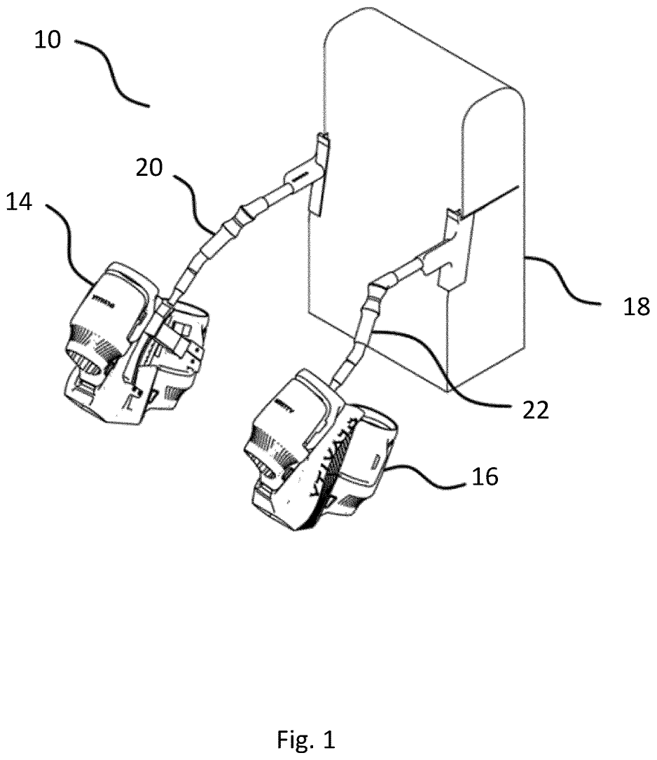

FIG. 1 shows a wearable flight system in accordance with the invention;

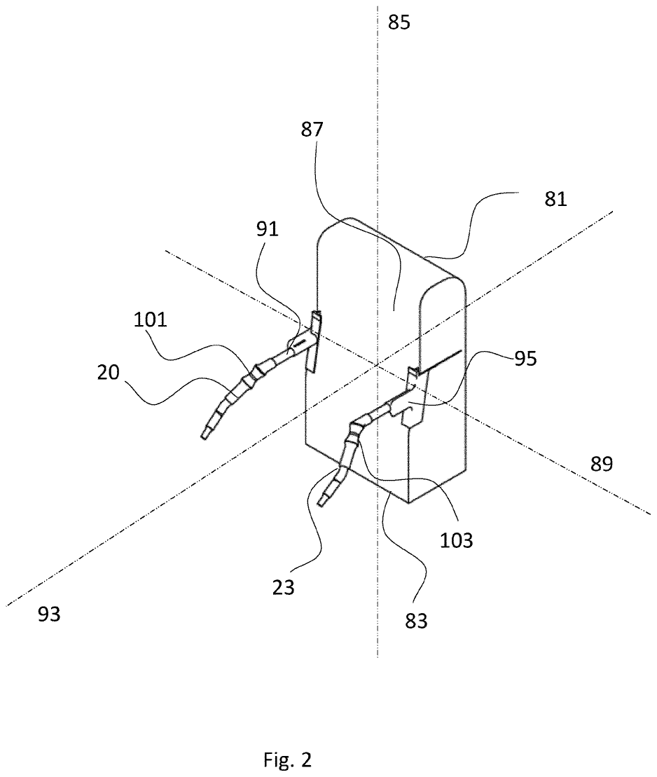

FIG. 2 shows a body support structure and right and left supports arms for use in an embodiment of the invention;

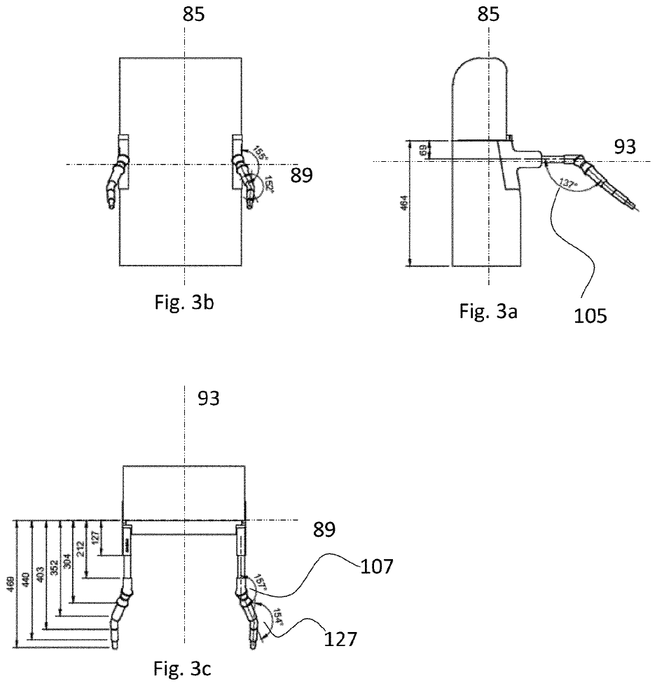

FIGS. 3a to 3c shows front, left and top protectional views of the body support structure and right and left supports arms of FIG. 2;

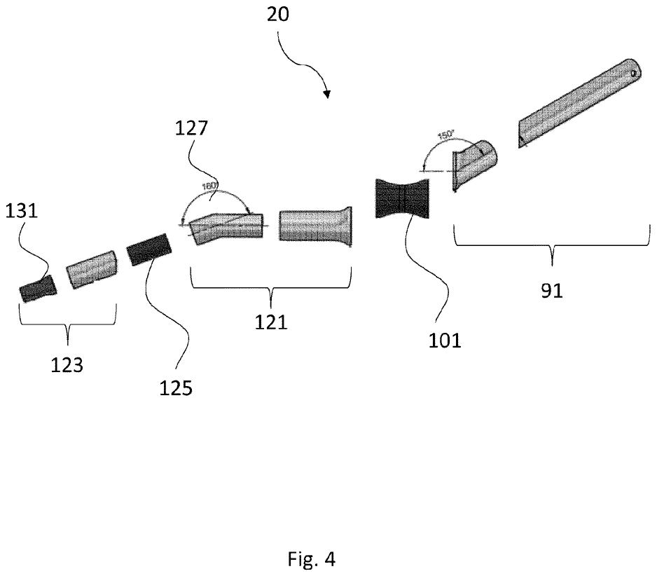

FIG. 4 shows an exploded view of the right support arm of FIG. 2;

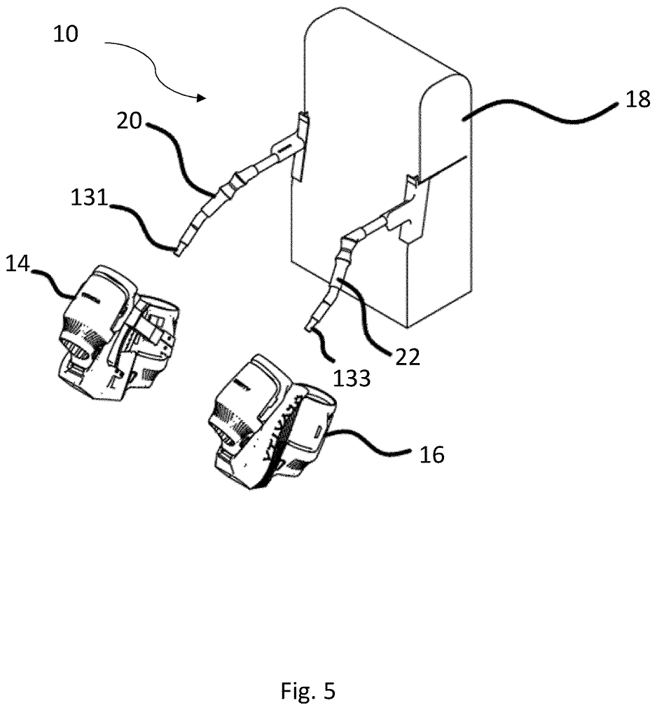

FIG. 5 shows a second configuration of a wearable flight system in accordance with the invention;

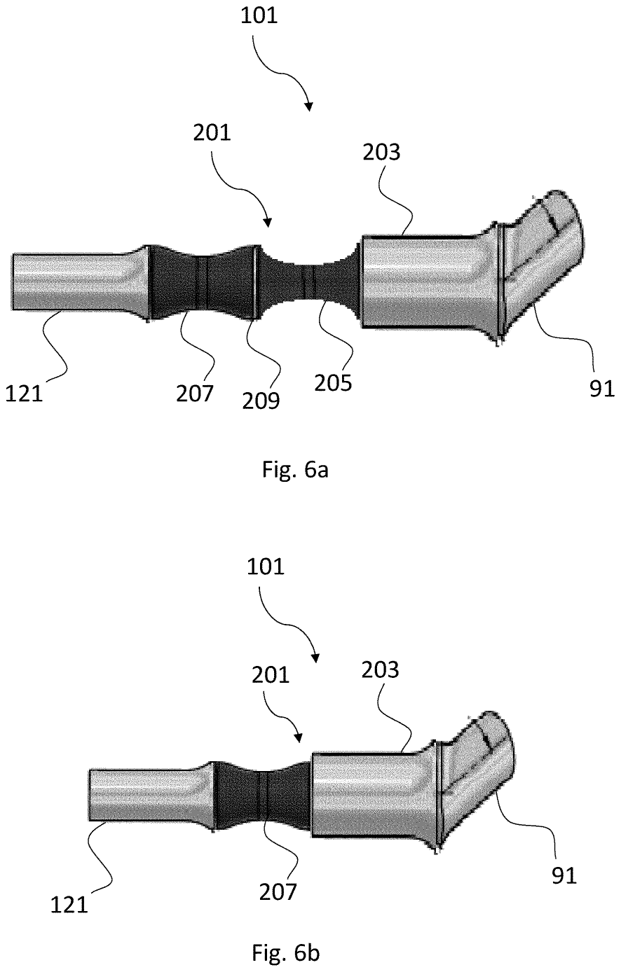

FIGS. 6a and 6b show a rotational joint of the wearable flight system of FIG. 1 in (6a) a lower stiffness configuration and (6b) a higher stiffness configuration;

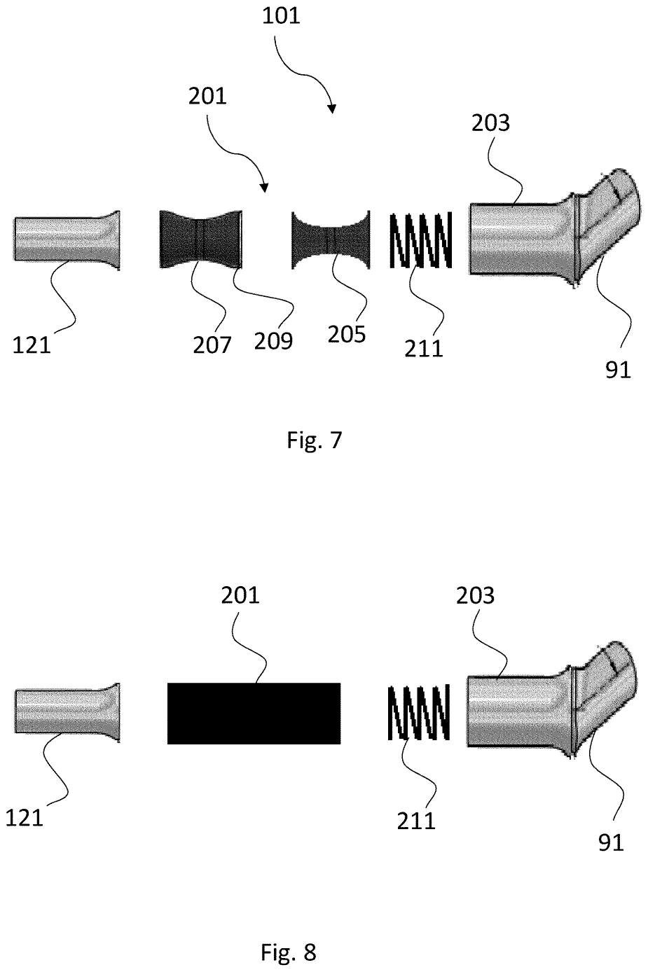

FIG. 7 shows an exploded view of the rotational joint of FIGS. 6a and 6b; and

FIG. 8 shows an exploded view of an alternative embodiment of the rotational joint of FIG. 7.

As shown in FIG. 1, a wearable flight system 10 comprises a right hand propulsion unit 14, a left hand propulsion unit 16, and a body support structure 18. The wearable flight system 10 is configured to be worn by a user.

The right hand propulsion unit 14 is preferably configured to be worn on the user's right hand or forearm, and/or held by the user's right hand. The left hand propulsion unit 16 is preferably configured to be worn on the user's left hand or forearm, and/or held by the user's left hand.

The body support structure 18 is configured to be worn on the user's body, torso, and/or waist. In addition, the body support structure 18 is configured to support the user's body, preferably in flight. When not in flight, the body support structure 18 is supported by the user's body.

The body support structure 18 may comprise a harness and/or straps for engaging the user's body. In particular, the body support structure 18 may comprise shoulder straps for engaging the user's shoulders and a belt for engaging the user's waist. Optionally, the body support structure 18 comprises leg straps for engaging the user's legs. This may be a five-point harness. For example, webbing straps connecting the shoulder straps, leg straps, and belt can pass through strap holes in a part of the body support structure 18 so that the straps of the harness can form a full loop for securing the user.

Alternatively, the body support structure 18 may comprise a seat, jacket, exoskeleton and/or other item of clothing for securing the body support structure 18 the user's body. As will be appreciated, rigid members may be used to engage the user's body as additional, or alternative, means for transferring the load of the user to the body support structure. In any event, the body support structure 18 can be said to be wearable by the user.

The body support structure 18 may further comprise electronics for controlling the wearable flight system 10. The wearable flight system 10 further comprises an energy storage device for providing power to the propulsion assemblies and this may be included within the body support structure. This may comprise a fuel storage vessel for supplying fuel to turbines and/or batteries for powering fans and/or control circuitry.

In use and/or in flight, the right and left propulsion units 14, 16 produce a thrust force. The right and left hand propulsion units 14, 16 may comprise turbines and/or ducted fans. The right and left propulsion units 14, 16 preferably each comprise a means for providing more than one thrust force, that is, a thrust force along two or more distinct lines. This can be accomplished with a plurality of turbines and/or ducted fans, or multiple outlets/nozzles from a single turbine or ducted fan.

The right and left hand propulsion units 14, 16 may comprise a handle, one or more straps and/or or a sleeve such that the thrust force may be transferred to the user from the right and left hand propulsion units 14, 16. Transferring the thrust force to the user will enable the user to fly (that is, move without being in contact with the ground (direct or indirect) for an extended period of time). The thrust force generated can balance and preferably exceed the combined weight of the user and the wearable flight system 10.

If a sleeve is included, it is preferable that the sleeve extends over a length of from 20 cm to 50 cm, and more preferably a length of from 30 cm to 35 cm, so that the right and left hand propulsion units 14, 16 are held in alignment with the user's arm, but do not hinder articulation of the elbow. The sleeve may have a diameter in the range 8 cm to 10 cm. Preferably, the sleeve is padded on the inside. The padding may be shaped to the general contour of an arm so as to distribute support comfortably.

Irrespective of the number of lines along which thrust is generated, each of the right and left hand propulsion units 14, 16 as a whole are preferably arranged to provide a net thrust along an axis that generally corresponds with the user's right or left forearm respectively, when the right and left hand propulsion units 14, 16 are worn. The axis along which the net thrust acts can also be described as an axis of thrust. That is, the right and left hand propulsion units 14, 16 are each preferably arranged, as a whole, to provide a net thrust along a longitudinal axis of their respective sleeves, if present.

Preferably, the right and left hand propulsion units 14, 16 are each configured to produce thrust along at least two non-parallel vectors. This has been shown to improve the stability of the hand propulsion units.

The wearable flight system 10 may further comprise a body propulsion assembly. The body propulsion assembly may be attached to the body support structure 18 and may comprise turbines and/or ducted fans. The body propulsion assembly is configured to produce a thrust force transferred directly to a user's torso. It is preferable that the body support structure 18 is sized and shaped such that the location at which thrust is generated by the body propulsion assembly (i.e., the nozzles of the turbines and/or the fan of a fan driven by a motor) is located between the lower edge of the rib cage and knees, and more preferably between the upper extent of the lumbar vertebrae and the user's upper thigh.

Preferably, the body support structure 18 may be arranged to hold the body propulsion assembly at a fixed angle relative to the user's torso when the body propulsion assembly is worn by (i.e., engages) the user. The body support structure 18 defines a body axis 85, which is parallel with a line extending between the centre of the user's head and the centre of the user's waist when the body support structure 18 is worn. The body support structure 18 may hold the body propulsion assembly at an elevation angle to the body axis 85. That is, the body propulsion elevation angle is the angle in the sagittal plane (the plane that divides the user into right and left sides) between the net thrust produced by the body propulsion assembly and the body axis 85.

In other words, the body support structure 18 may be configured to hold a user's body relative to the body propulsion assembly such that a line extending between the centre of the user's head and the centre of the user's waist extends relative to the orientation of the net thrust provided by the body propulsion assembly by the body propulsion elevation angle.

The body propulsion elevation angle is greater than zero. Preferably, the body propulsion elevation angle is at least 10 degrees and is no more than 30 degrees. This choice of angle has been found to improve stability and protect the user's legs without greatly reducing total lift.

The wearable flight system 10 further comprises a right support arm 20 and a left support arm 22. The right support arm 20 extends from the body support structure 18 to the right hand propulsion unit 14, and the left support arm 22 extends from the body support structure 18 to the left hand propulsion unit 16.

The right support arm 20 extends from the body support structure 18 for positioning the right support arm 20 under the user's right armpit and the left support arm 22 extends from the body support structure 16 for positioning the left support arm 22 under the user's left armpit. Less preferably, the right and left support arms could extend from other positions on the body support structure 16, but this results in poorer control for the user.

When worn by a user, the right support arm 20 may follow the inside of the user's right arm and the left support arm 22 may follow the inside of the user's left arm. For this purpose, the spacing between the point of attachment of the right support arm 20 and the body support structure 18 and the point of attachment of the left support arm 22 and the body support structure 18 is in the range 360 mm to 510 mm and is preferably in the range 430 mm to 440 mm.

The right and left support arms 20, 22 each comprise one or more rigid strut(s). The rigid struts can allow a portion of the thrust force to be transferred from the right and left hand propulsion units 14, 16 connected to the right and left support arms 20, 22 to the body support structure 18. In this way, the load carried by the user can be lessened, enabling a less tiring flying experience.

The right and left support arms 20, 22 may comprise one or more of metal, a composite and plastic materials.

At least a portion of the thrust force generated by the right and left hand propulsion units 14, 16 may be transferred from the right hand propulsion unit 14 to the body support structure 18 via the right support arm 20, and at least a portion of the thrust force generated by the right and left hand propulsion units 14, 16 may be transferred from the left hand propulsion unit 16 to the body support structure 18 via the left support arm 22. Preferably at least 50%, and even more preferably at least 75% of the thrust force from the right and left hand propulsion assemblies 14, 16 can be can be transferred directly to the body support structure 18 via the right and left support arms 20, 22. The thrust force may then be transferred from the body support structure 18 to the user. Transferring the thrust force to the user via the right and left support arms 20, 22 and the body support structure 18 can reduce the force carried by the user's arms since it is transferred directly to the user's body rather than through the user's arms. In addition, part of the thrust force transferred to the body support structure 18 via the right and left support arms 20, 22 is necessary to carry the weight of the body support structure 18. This thrust force is therefore not transferred through the user at all. Without the right and left support arms 20, 22 the thrust force necessary to carry the weight of the body support structure 18 is also transferred through the user. Therefore, transferring the thrust force necessary to balance the weight of the body support structure 18 directly to the body support structure 18 via the right and left support arms 20, 22, rather than through the user, reduces the forces experienced by the user.

As shown in FIG. 2, The body support structure 18 comprises a top 81 and a bottom 83. When worn, the top of the body support structure 18 is configured to be closer to a user's head than the bottom body support structure 18. The body support structure 18 extends along the body axis 85 between the top 81 and the bottom 83.

The body support structure 18 defines or comprises a rigid member 87 extending between the right and left support arms 20, 22. The rigid member 87 extends in a transverse direction (that is, it has a dimension measurable along a transverse axis 89, without necessarily being parallel with the transverse axis 89). The body axis 85 is perpendicular to the transverse axis 89. The rigid member 87 may extend parallel to the transverse axis 89 or alternatively extend in a direction with a component along the transverse axis. The rigid member 87 may also extend in a direction with a component along the body axis 85.

The body support structure 18 further comprises a right extension 91 extending perpendicularly from the rigid member 87 and a left extension 95 extending perpendicularly from the rigid member 87. The right and left extensions may extend forwardly (that is, they have a dimensional component along a forward axis 93 which is perpendicular to the transverse axis 89 and is perpendicular to the body axis 85). he right and left extensions 91, 95 may not extend exclusively along the forward axis and rather extend in a direction with a component along the forward axis 93. The right extension 91 is arranged for positioning the right support arm 20 under the user's right armpit and the left extension 95 is arranged for positioning the left support arm 22 under the user's left armpit. The right and left extensions 91, 95 together with the rigid member 87 of the body support structure 18 may collectively form a rigid body, such as a frame.

The right and left extensions 91, 95 are preferably adjustable in length for accommodating users of varying size.

In preferred embodiments in which the extensions 91, 95 are adjustable, the right and left extensions 91, 95 comprise two coaxial tubes, wherein an inner tube is slidably located within an outer tube, and a fixing mechanism for fixing the inner tube relative to the outer tube. One of the inner or outer tubes is connected to the right or left support arm 20, 22 while the other of the outer or inner tube is connected to the rigid member 87 of the body support structure 18. Any other adjustable mechanism may be used. The right and left extensions 91, 95 are preferably adjustable in length by a range of at least 40 mm, at least 45 mm, or at least 50 mm, and the right and left extensions 91, 95 may each be adjustable between 170 mm and 220 mm.

The right support arm 20 is connected to the body support structure 18 by a right rotational joint 101 and the left support arm 22 is connected to the body support structure 18 by a left rotational joint 103. The right rotational joint 101 and the left rotational joint 103 both comprise a resilient member. Due to the right and left rotational joints 101, 103 the right and left support arms 20, 22 can rotate relative to the body support structure 18.

The right rotational joint 101 is connected to the body support structure 18 at a first side and the right support arm 20 at a second side. If the right extension 91 is there the right rotational joint 101 is connected to the right extension 91 at the first side. The left rotational joint 103 is connected to the body support structure 18 at a first side and the left support arm 22 at a second side. If the left extension 95 is there, the left rotational joint 103 is connected to the left extension 95 at the first side.

Preferably, the right and let rotational joints 101, 103, allow a range of motion in a plurality of planes. This distinguishes the right and let rotational joints 101, 103 from simple hinges. The right support arm 20 is movable in any plane along which the right support arm 20 extends. The left support arm 22 is movable in any plane along which the left support arm 22 extends.

The direction of extension of the support arm is the direction along which at least a portion, such as a proximal portion or a distal portion, of the support arm extends, and/or a line joining the two ends of the support arm extends. The support arms are considered to extend along a plane if at least a portion, such as a proximal portion or a distal portion, of the support arm extends along the plane, and/or if a line joining the two ends of the support arm extends along the plane.

A preferable rotational joint is formed by the use of the respective resilient member as a bridge between the body support structure 18 and the support arm 20, 22, such that rotation of the support arm 20, 22 relative to the body support structure 18 bends the resilient member.

For example, the resilient member of the right rotational joint 101 is connected to the body support structure 18 at a first side and the right support arm 20 at a second side. The resilient member of the left rotational joint 103 is connected to the body support structure 18 at a first side and the left support arm 22 at a second side.

The resilient member behaves in an elastic manner under bending so as to provide a restoring force towards a neutral position in its undeformed state. To achieve this, the resilient member may be formed of an elastomeric material. Alternatively, the resilient member may be a spring. The resilient member is thus able to deform and/or store elastic energy.

The neutral position is the position at which the resilient members are not deformed and/or have a minimum elastic energy. The neutral position is the position to which the resilient member returns when not under external forces.

The right and left rotational joints 101 and 105 may consist of the resilient members. The right and left rotational joints 101, 105 may comprise Boge joints (also known as power joints). These are rubber, hourglass-shaped joints typically used in windsurfing applications as a means for transferring wind load from a sail to a board. These joints can allow rotation in any direction and provide a restoring force when deformed.

Less preferably, the right and left rotational joints 101, 105 may comprise other materials in addition to the resilient member. For example, the right and left rotational joints 101, 105 may comprise a universal joint combined with elastic material to bias the right joints in a certain direction. However, a joint comprising a hinge about a shaft, even a universal joint, is less desirable, since it does not provide equal resistance to bending in all degrees of freedom and can provide resistance to motion about the longitudinal axis of the arm 20, 22.

A preferred resilient member for use in one of the rotational joints 101, 105 may have an hourglass shape or may taper towards a central narrowed region.

For example, a preferred resilient member for use in one of the rotational joints 101, 105 may comprise two connector portions with a neck portion therebetween. The neck portion is narrower (that is, has a smaller width perpendicular to its length) than the connector portions. When such a resilient member is used, a first connector portion is proximal and/or connected to the body support structure 18, while. a second connector portion is proximal and/or connected to the right or left support arm 20, 22. If the right or left extension 91, 95 is present, the first connector portion is connected to the right or left extension 91, 95.

The aforementioned shape of the resilient member can result in desired flexible characteristics.

Due to the resilient members, the wearable flight system 10 can passively bias the right and left support arms 20, 22 to predetermined orientations relative to the body support structure 18, and therefore the right and left hand propulsion assemblies 14, 16 to a desirable location. Therefore, the resilient members can reduce the effort needed by a user to operate the wearable flight system 10 by providing a restoring force to aid movement of the right and left hand propulsion assemblies 14, 16 into a desirable configuration for flight. In addition, the use of the resilient member can aid the transfer of thrust force from the right and left support arms 20, 22 to the body support structure 18, while giving the user flexibility to enhance control of the wearable flight system 10.

As shown in FIG. 3a, in the neutral position the right and left support arms 20, 22 are angled from the forward axis 93 in the sagittal plane by an elevation angle 105 of between 110 and 170 degrees, and preferably between 135 and 140 degrees. This may also be described using an angle in the sagittal plane measured from the body axis 85, of between 20 and 80 degrees, and preferably between 45 and 50 degrees. The sagittal plane may also be described as the plane defined by the body axis 85 and the forward axis 93.

As shown, the right and left support arms 20, 22 are downwardly inclined relative to the body axis. In addition, the right and left support arms 20, 22 extend away from the body support structure 18. The right and left support arms 20, 22 are shown to be angled from the forward axis 93 in the vertical plane in the same direction, and by the same value. That is, the right and left support arms 20, 22 are arranged symmetrically across the sagittal plane. Since the right and left support arms 20, 22 are independently moveable, they will not always have the same orientation. However, in the neutral position they are positioned symmetrically since this aids the user's stability and control in flight.

When the wearable flight system 10 is worn in a deactivated state, the right and left hand propulsion assemblies 14, 16 bias the right and left support arms 20, 22 downwards due to their weight. This weight will bias the right and left support arms 20, 22 towards the bottom 83 of the body support structure 18. Therefore, the resilient member will provide a restoring force biasing the right and left hand propulsion units 14, 16 away from the bottom 81 of the body support structure 18, since that is back towards the neutral position. In other words, the resilient members can provide a restoring force for increasing the elevation angle 105.

In addition, the restoring force biasing the right and left hand propulsion units 14, 16 away from the bottom 81 of the body support structure 18 can aid the user in flight. When flying forward at speed, aerodynamic flight loads will be felt on the user's arms pushing their arms and the right and left hand propulsion assemblies 14, 16 towards the bottom 83 of the body support structure 18. The restoring force can aid the user in resisting the aerodynamic flight loads felt on the user's arms.

As shown in FIG. 3c, in the neutral position, the right and left support arms 20, 22 are angled from the forward axis in a transverse plane by a yaw angle 107 of between 135 and 180 degrees and preferably between 155 and 160 degrees. The transverse plane is the plane defined by the transverse axis 89 and the forward axis 93. The right and left support arms 20, 22 are shown as angled from the forward axis in the transverse plane in opposite directions and/or by the same yaw angle. In other words, the right and left support arms 20, 22 diverge in the transverse plane as they extend away from the body support structure 18, and the right and left support arms 20, 22 extend away from each other. This also ensures that the right and left support arms 20, 22 are arranged symmetrically across the sagittal plane.

Preferably, the right support arm 20 engages the right hand propulsion unit 14 at a location displaced from the axis of thrust of the right propulsion unit 14, preferably displaced to the left and/or towards a centre of the body support structure 18 and the left support arm 22 engages the left hand propulsion unit 16 at a location displaced from the axis of thrust of the left propulsion unit 16, preferably displaced to the right and/or towards a centre of the body support structure 18. In this way, the thrust of each propulsion unit 14, 16 may be more generally aligned with the user's arms, while the support arms 20, 22 follow the insides of the user's arms.

As a result of the above, there is an offset between the location of engagement between the hand propulsion units 14, 16 and support arms 20, 22, and the axis of thrust of the right propulsion unit. Due to the offset, the thrust forces generate moments around the right and left rotational joints 101, 103 biasing the right and left support arms 20, 22 away from each other in normal flight. In such a situation, the resilient members provide a restoring force biasing the right and left hand propulsion units 14, 16 towards each other. This aids the user in resisting the moments generated and holding the right and left hand propulsion assemblies in a desirable location and thereby reduces the flying effort required on the part of the user.

In use, the wearable flight system 10 can reach an equilibrium position in which the moments created by the thrust forces biasing the right and left support arms 20, 22 away from each other are at least partially balanced by the restoring force biasing the right and left hand propulsion units towards each other. The wearable flight system 10 may require user input to hold the wearable flight system 10 in the equilibrium position, in which case the moments created by the thrust forces are balanced by the restoring force from the resilient members and a moment generated by the user. However, the efforts of the user are much less than would be required in the absence of the support arms 20, 22.

The right and left support arms 20, 22 preferably have a limited range of motion. For example, the right and left support arms 20, 22 are able to move in the sagittal plane away from the neutral position by less than 60 degrees, preferably by less than 50 degrees, and even more preferably by less than 40 degrees. In addition, the right and left support arms 20, 22 are able to move in the transverse plane away from the neutral position by less than 50 degrees, preferably by less than 45, and even more preferably by less than 40 degrees. The limited range of motion may be enforced by stop surfaces which prevent motion past a certain angle. However, in flight it is unlikely that the user will be able to push with enough force against the restoring force of the resilient members past a certain point. Therefore, the limited range of motion is preferably ensured by the use of resilient members of sufficient stiffness that the user will not be practically able to move the support arms past those locations in flight, even though the joints are free to move further. Having a limited range of motion reduces the user effort needed to operate the wearable flight system 10 while allowing the user sufficient freedom to use the system effectively.

As shown in FIG. 4, the right support arm 20 comprises a right upper arm member 121, a right lower arm member 123 and a right elbow joint 125 joining the right upper arm member 121 to the right lower arm member 123. The right upper and lower arm members 121, 123 are both rigid members. The right upper arm member 121 is proximal to the body support structure 18 and is connected to the right rotational joint 101. The right lower arm member 123 is proximal to the right hand propulsion unit 14 and is connectable and/or connected with the right hand propulsion unit 14.

The left support arm 22 comprises a left upper arm member, a left lower arm member and a left elbow joint joining the left upper arm member to the left lower arm member. The left upper and lower arm members are both rigid members. The left upper arm member Is proximal to the body support structure 18 and is connected to the left rotational joint 103. The left lower arm member is proximal to the left hand propulsion unit 16 and is connectable and/or connected with the left hand propulsion unit 16. In general, the left support arm 22 may comprise corresponding features to the right support arm 20.

The right and left support arms 20, 22 preferably comprise complementary engageable surfaces on the upper arm members 121 and the lower arm members 123 for restricting a range of motion of the right and left elbow joints 125. The complementary surfaces are configured to engage prior to the range of motion being exceeded, thereby stopping the elbow joints from exceeding the range of motion. The complementary surfaces define stops for preventing rotation beyond a predetermined angular displacement. The right and left elbow joints 105 each may have a range of motion less than 25 degrees, less than 20 degrees, or less than 15 degrees. Having a limited range of motion can reduce the user effort needed to operate the wearable flight system 10 while allowing the user sufficient freedom to use the system effectively.

The right and left elbow joints 105 each preferably allow a range of motion in a plurality of planes. This distinguishes the right and left elbow joints 105 from simple hinges. The right lower arm member 123 is movable in any plane along which the right upper arm member 121 extends. The left lower arm member is movable in any plane along which the left upper arm member extends. The right and left lower arm member 123 are not equally movable in all planes, rather, the right and left lower arm member 123 have a greater degree of motion in a single plane as compared to the other planes.

The right and left elbow joints 125 each comprise a resilient member extending between the upper and lower arm members. Each upper and lower arm member 121, 123 comprise two tubular sections, wherein the resilient member is inserted into both tubular sections. In other words, the upper arm member comprises a first tubular section while the lower arm member comprises a second tubular section and the resilient member is inserted into both sections and extends between them. This joint may be a tendon joint. A tendon joint is a joint typically used in windsurfing applications as a means for transferring wind load from a sail to a board. The joint comprises a cylinder of stiff elastic material extending between two members. The resilient member may comprise features described in reference to the resilient member of the right and left rotational joints 101, 103.

The lower arm members 123 can move relative to the upper arm members 121 over a range of motion about a neutral elbow position in which the upper arm member is at an obtuse angle relative to the lower arm member. The obtuse angle is an angle more than 90 degrees and less than 180 degrees. The right and left support arms 20, 22 thereby follow the natural shape of a human arm and elbow.

The resilient member of the elbow joints 125 provides a restoring force when displaced from the neutral elbow position. The restoring force acts to increase the angle between the upper arm members 121 and lower arm members 123. The use of the resilient member can aid the transferral of thrust force along the right and left support arms 20, 22, while giving the user flexibility to enhance control of the wearable flight system 10.

The neutral elbow position is one in which there is an elbow angle 127 of between 130 and 180 degrees, and preferably between 155 and 165 degrees between the upper arm member 121 and lower arm member 123. As most clearly shown in FIG. 3C, the elbow angle 127 is preferably chosen such that the lower arm members 123 extend roughly parallel with the forward axis 93 in the transverse plane. Therefore, if the yaw angle 107 is set as a lower angle, the elbow angle 127 is also set as a lower angle. The lower arm members 123 preferably extends within 10 degrees of the forward axis 93 in the transverse plane The complementary engageable surfaces of the right or left support arms 20, 22 are preferably arranged such that the angle between the right or left upper arm member 121 and right or left lower arm member 123 cannot be increased beyond the elbow angle 127, and only decreased.

The neutral elbow position is preferably achieved by the upper arm members 121 comprising a bent portion at an end proximal to the elbow joints 125 as shown in FIG. 4. Namely, the upper arm members 121 is bent at the elbow angle 127 in the bent portion. As illustrated, this may be a sharp turn, but could alternatively be a gradual turn. Due to this, in the neutral elbow position, an axis through the upper end of the lower arm member 123 is at an angle to an axis of the upper end of the upper arm member 121 by the elbow angle 127. Alternatively, the lower arm member 123 could comprise the bent portion at its upper end proximal to the elbow joints 125 to achieve the same effect. A further option is for both the upper and lower arm members 121, 123 to be straight and the elbow joint 125 to comprise the bent portion, for example, if the resilient member was not straight but bent.

In general, the elbow angle 127 is defined as between the extension of the longitudinal axis through the upper end of the upper arm member 121 and the extension of the longitudinal axis through the upper end of the lower arm member 123.

The right upper arm member 121 and left upper arm member are preferably adjustable in length for accommodating users of varying size.

One way of making the upper arm members 121 adjustable is to form the right and left upper arm members 121 from two coaxial tubes, wherein an inner tube is slidably located within an outer tube, and a fixing mechanism for fixing the inner tube relative to the outer tube. One of the inner or outer tubes may be connected to the right or left rotational joint 101, 103, while the corresponding outer or inner tube is connected to the right or left elbow joint 125. Any other adjustable mechanism may be used. The right and left upper arm members 121 are preferably adjustable in length by a range of at least 15 mm, at least 20 mm, or at least 25 mm, and the right and left upper arm members 121 may each be adjustable between 95 mm and 120 mm.

As shown in FIG. 5, the right hand propulsion unit 14 is preferably detachably connected to the right support arm 20 and the left hand propulsion unit 16 is detachably connected to the left support arm 22.

As shown in more detail in FIG. 4 the right support arm 20 comprises a right connection post 131. The connection post 131 is configured to engage a corresponding recess in the right hand propulsion unit 14 so that the right hand propulsion unit 14 can be connected to the right support arm 20. Preferably, the right hand propulsion unit 14 is loosely connected to the right support arm 20 such that the right hand propulsion unit 14 can be removed from the right support arm 20 easily, even during flight. Similarly, the left support arm 22 comprises a left connection post 133. The connection between the left support arm 22 and the left hand propulsion unit 16 has corresponding features to those described in connection with the right hand propulsion unit 14 and the right support arm 20. Being able to remove the right and left hand propulsion units 14, 16 from the right and left support arms 20, 22 easily, even during flight allows the user to disconnect the propulsion units 14, 16 from the right and left support arms 20, 22 at any time for improving the controllability of the wearable flight system 10 as necessary.

Preferably, the right connection post 131 comprises a protrusion at an end proximal to the right hand propulsion unit 14 for engaging a complementary aperture in the recess of the right hand propulsion unit 14. Alternatively, the connection post 131 comprises the aperture while the recess the protrusion. Such a feature prevents rotation of the right hand propulsion unit 14 relative to the right support arm 20. The left support arm 22 the left hand propulsion unit 16 may comprise corresponding features. If the right and left hand propulsion units 14, 16 were able to rotate, then the flexible response of the right and left rotational joints 101, 103 may become sub-optimal as they are designed for a certain orientation of the wearable flight assembly 10. Preventing rotation of the right and left hand propulsion units 14, 16 relative to the right and left support arms 20, 22 can ensure the response of the right and left support arms 20, 22, due to the right and left rotational joints 101, 103 is as intended.

Whereas the above support arms are described as being used with propulsion units that may be worn or held directly by the user's left hand and/or forearm, this is not essential and embodiments are envisaged in which it is the left and right support arms (rather than the left and right hand propulsion units themselves), which comprise a member (for example, a handle and/or sleeve) for being worn or held by the user's left hand and/or forearm.

There is now described a mechanism for adjusting a stiffness of the rotational joints.

As explained above, the rotational joints by which the support arms are connected to the body support structure provide a certain level of stiffness and flexibility between the support arm and the body support structure. This allows a portion of the load to be transferred from the propulsion units to the body of the support structure, whilst allowing flexibility and thus manoeuvrability of the wearable flight system.

The mechanism for adjusting the stiffness of the joint allows this stiffness to be varied based on the situation in flight. For example, during general flight, or faster flight, a higher level of stiffness may be desired, which may be the default level of stiffness. This ensures that sufficient support is provided to the user, in particular to overcome aerodynamic and thrust loads experience on the user's limbs during flight. However, during slower flight, or during complex manoeuvres, higher flexibility and manoeuvrability of the support arms and thus the propulsion units may be desired, which is aided by a lower stiffness of the joints. Therefore, a mechanism for adjusting the stiffness of the joints allows both of these requirements to be realised.

As shown in the embodiment of FIGS. 6 to 8, the left and right rotational joints 101, 103 each comprise a resilient member with at least two portions of differing stiffnesses 201, and a rigid sleeve 203. As shown in FIG. 6a, the rigid sleeve 203 is attached to the extension at 91, and the resilient member 201 is attached to the upper arm member 121. The resilient member 201, at an end distal from the upper arm member 121, is attached to a location within the rigid sleeve 203. The resilient member 201 may be slidably mounted within the rigid sleeve 203 such that the resilient member 201 can at least partially be extended from and retracted into the rigid sleeve 203. The resilient member 201 may be attached to a member mounted on rails within the rigid sleeve 203 to achieve this.

Of course, in an embodiment not comprising the extension 91, or the upper arm member 121, the rigid sleeve 203 will be attached to the body support structure 18 and the resilient member 201 will be attached to the support arm 20, 22. In addition, the arrangement of the joint 101 may be reversed such that the rigid sleeve 203 is attached to the support arm 20, 22, and the resilient member 201 is attached to the extension 91 or the body support structure 18.

FIG. 6a shows the rotational joint 101 in a configuration with lower stiffness, in other words with increased flexibility. As shown in FIG. 6a, the resilient member with at least two portions of differing stiffness 201 comprises a portion with lower stiffness 205, and a portion with higher stiffness 207. In the lower stiffness configuration, or extended configuration, the lower stiffness portion 205 is extended from the rigid sleeve 203. Thus, the lower stiffness portion 205 is able to deform. This allows the support arm to move with increased flexibility, because it only requires the lower stiffness portion 205 to deform for the support arm 20, 22 to move.

in FIG. 6b, the rotational joint 101 is in a position with increased stiffness in which the portion of the resilient member with lower stiffness 205 is retained within the rigid sleeve 203, and for this reason is not visible in FIG. 6b. Thus, in the higher stiffness configuration, or a retracted configuration, movement of the support arm 20, 22 is not able to deform the lower stiffness portion 205, and only deformation of the higher stiffness portion 207 will occur. This ensures that there is reduced flexibility and increased stiffness of the joint 101 in the retracted configuration, because deformation of the higher stiffness portion 207 is necessary for the support arm 20, 22 to move. In this configuration, only the higher stiffness portion 207 is visible, and able to deform.

The user can adjust the flexibility of the joint 101 by extending the resilient member with at least two portions of differing stiffness 201 from the higher stiffness configuration shown in FIG. 6b to the lower stiffness configuration shown in FIG. 6a. This can be achieved by “punching out” the support arms 20, 22, meaning extending them further away from the body support 18, such that the resilient member 201 is extended from the rigid sleeve 203.

The joint 101 or, in particular, the resilient member with at least two differing portions of different stiffness 201, may also comprise a rigid member 209 between the portions of differing stiffness, which may take the form of a solid disc. In other words, the lower stiffness portion 205 may be attached to one side of the rigid member 209, and the higher stiffness portion 207 may be attached to the opposite side of the rigid member 209. The rigid member 209 may contact and/or engage with the rigid sleeve 203 when in the retracted, high stiffness configuration, to ensure that forces from the support arm 20, 22 are not transmitted to the lower stiffness portion 205 and only the higher stiffness portion 207 deforms. In other words, the rigid member 209 may ensure that force is transferred directly from the higher stiffness portion 207 to the rigid sleeve 203.

FIG. 7 shows an exploded view of the rotational joint 101 described above in relation to FIGS. 6a and 6b. FIG. 7 additionally shows an optional biasing member 211, which may take the form of a helical spring. When assembled, the biasing member 211 is located within the rigid sleeve 203 and attached to the side of the resilient member with at least two portions of differing stiffness 201 at the opposite side from the support arm 20, 22. In particular, the biasing member 201 is attached to the lower stiffness member 205 opposite to the side of the lower stiffness member 205 attached to the higher stiffness member 207. The biasing member 201 is arranged to bias the lower stiffness portion 205 into the rigid sleeve 203, such that the joint 101 will tend to the higher stiffness, retracted, configuration. The biasing member 211 need not take the form of a metal spring, and any member capable of biasing the lower stiffness portion 205 into the rigid sleeve 203 may be used.

Both the higher and lower stiffness portions 205, 207 may be two distinct resilient members 205, 207 with differing stiffnesses in which the higher stiffness resilient member 207 is attached to the lower stiffness resilient member 205. Each resilient member 205, 207 may each comprise Boge joints (also known as power joints), and have the features described above in relation to the right and left rotational joints 101, 103. The only difference between the two resilient members 205, 207 is that they have different stiffnesses, and therefore different flexural properties, which may be accomplished by using resilient members of different shapes, or different materials.

The resilient member with at least two portions of differing stiffness 201 need not comprise two distinct resilient members attached to one another, as shown in FIGS. 6a, 6b and FIG. 7.

FIG. 8 shows an alternative embodiment in which the resilient member 201 is a single resilient member with a constant stiffness along its length.

In such an embodiment, the resilient member 201 is joined at one end to the support arm 20, 22, or the upper arm member 121 if this is present, and at the second end to the body support structure 18 via the rigid sleeve, or the biasing member 211 if this is present. Part of the resilient member 201 can be retained within the rigid sleeve 203 in a higher stiffness configuration, such that only the part of the resilient member 201 is able to deform.

Such an arrangement may result in a joint 101 with two distinct levels of stiffness, and would further have a plurality of different stiffness properties depending on what extent the resilient member 201 is extended beyond the rigid sleeve 203. Therefore, a range of stiffnesses of the joint 101 could be available for the user to select based on how far the resilient member 201 is extended from the rigid sleeve 203.

In FIG. 8 the resilient member 201 may have a varying stiffness along its length. The varying stiffness may be achieved by altering the material properties of the resilient member 201 along its length.

In such an embodiment, the resilient member 201 is joined at one end to the support arm 20, 22, or the upper arm member 121 if this is present, and at the second end to the body support structure 18 via the rigid sleeve, or the biasing member 211 if this is present. The stiffness may increase from the end of the resilient member 201 attached to the body support structure 18 towards the end attached to the support arm 20, 22. The part(s) of the resilient member 201 with lower stiffness is retained within the rigid sleeve 203 in the higher stiffness configuration, such that only the part(s) of the resilient member 201 with higher stiffness are able to deform.

Such an arrangement may result in a joint 101 with not just two distinct levels of stiffness (as will be the case with the embodiment above with two distinct resilient members 207, 205), and would rather have a plurality of different stiffness properties depending on what extent the resilient member 201 is extended beyond the rigid sleeve 203. This can also be achieved by using more than two resilient members in the same manner as the higher and lower stiffness portions 205, 207 described above. Therefore, a range of stiffnesses of the joint 101 could be available for the user to select based on how far the resilient member 201 is extended from the rigid sleeve 203.

1. A wearable flight system for a user comprising:
a right hand propulsion unit;
a left hand propulsion unit;
a body support structure for being worn on the user's body;
a right support arm extending from the body support structure to the right hand propulsion unit and connected to the body support structure by a right rotational joint comprising a resilient member; and
a left support arm extending from the body support structure to the left hand propulsion unit and connected to the body support structure by a left rotational joint comprising a resilient member.

2. The wearable flight system of claim 1, wherein the resilient member is an elastic member and/or is formed of an elastomeric material.

3. The wearable flight system of claim 1, wherein the resilient member comprises two connecter portions and a neck portion therebetween wherein:
a first connector portion is proximal the body support structure;
a second connector portion is proximal the right or left support arm; and
the neck portion has a smaller width than the connecter portions, and/or the left and right rotational joints allow a range of motion in a plurality of planes.

4. (canceled)

5. The wearable flight system of claim 1, wherein the resilient member provides a restoring force when displaced from a neutral position.

6. The wearable flight system of claim 5, wherein:
the body support structure extends along a body axis between a top and a bottom, wherein the top is closer to a user's head than the bottom when worn; and
in the neutral position the right and left support arms are downwardly inclined relative to the body axis, preferably by an elevation angle in the range 20 to 50 degrees, the elevation angle being measured as the angle in a sagittal plane between the body axis and a line along which the support arms extend in the neutral position.

7. The wearable flight system of claim 5, wherein in the neutral position the right and left support arms diverge from each other.

8. The wearable flight system of claim 1, wherein:
the right support arm engages the right hand propulsion unit at a location displaced from an axis of thrust of the right propulsion unit, preferably displaced to the left and/or towards a centre of the body support structure; and
the left support arm engages the left hand propulsion unit at a location displaced from an axis of thrust of the left propulsion unit, preferably displaced to the right and/or towards a centre of the body support structure.

9. (canceled)

10. (canceled)

11. (canceled)

12. (canceled)

13. The wearable flight system of claim 1, wherein:
the right support arm extends from the body support structure for positioning the right support arm under the user's right armpit; and
the left support arm extends from the body support structure for positioning the left support arm under the user's left armpit, and/or-the body support structure further comprises a harness and/or straps for engaging the user's body.

14. (canceled)

15. The wearable flight system of claim 1, wherein the right and left support arms both comprise a rigid strut.

16. The wearable flight system of claim 1, wherein the right support arm comprises:
a rigid right upper arm member proximal to the body support structure;
a rigid right lower arm member proximal to the right hand propulsion unit; and
a right elbow joint joining the right upper arm member to the right lower arm member; and
the left support arm comprises:
a rigid left upper arm member proximal to the body support structure;
a rigid left lower arm member proximal to the left hand propulsion unit; and
a left elbow joint joining the left upper arm member to the left lower arm member.

17. The wearable flight system of claim 16, wherein:
the right support arm comprises complementary engageable surfaces on the right upper arm member and the right lower arm member for restricting a range of motion of the right elbow joint; and
the left support arm comprises complementary engageable surfaces on the left upper arm member and the left lower arm member for restricting the range of motion of the left elbow joint.

18. The wearable flight system of claim 16, wherein the right and left elbow joints each:
have a range of motion less than 25 degrees, preferably less than 20 degrees, and even more preferably less than 15 degrees; and/or
comprise a resilient member extending between the upper and lower arm members,
wherein each upper and lower arm member comprises two tubular sections, and the resilient member is inserted into both tubular sections.

19. (canceled)

20. (canceled)

21. The wearable flight system of claim 16, wherein:
the right lower arm member can move relative to the right upper arm member over a range of motion about a neutral elbow position in which the right upper arm member is at an obtuse angle relative to the right lower arm member; and
the left lower arm member can move relative to the left upper arm member over a range of motion about a neutral elbow position in which the left upper arm member is at an obtuse angle relative to the left lower arm member.

22. The wearable flight system of claim 21, wherein each resilient member provides a restoring force towards the neutral elbow position.

23. (canceled)

24. The wearable flight system of claim 1, wherein:
the right hand propulsion unit is detachably connected to the right support arm; and
the left hand propulsion unit is detachably connected to the left support arm; and/or
left support arm comprises a connection post inserted into a recess of the left hand propulsion unit; and
the right support arm comprises a connection post inserted into a recess of the right hand propulsion unit.

25. (canceled)

26. The wearable flight system of claim 1, wherein:
the right support arm comprises a protrusion and/or aperture at an end proximal to the right hand propulsion unit for engaging a complementary aperture and/or protrusion in the right hand propulsion unit for preventing rotation of the right hand propulsion unit relative to the right support arm; and
the left support arm comprises a protrusion and/or aperture at an end proximal to the left hand propulsion unit for engaging a complementary aperture and/or protrusion in the left hand propulsion unit for preventing rotation of the left hand propulsion unit relative to the left support arm.

27. The wearable flight system of claim 1, further comprising a body propulsion assembly attached to the body support structure.

28. The wearable flight system of claim 1, wherein the right rotational joint and left rotational joint each comprise:
a rigid sleeve and a resilient member, wherein a portion of the resilient member is retainable within the rigid sleeve; and/or
a rigid sleeve and a resilient member with at least two portions of differing stiffnesses, wherein a portion of the resilient member with lower stiffness is retainable within the rigid sleeve.

29. (canceled)

30. (canceled)

31. The wearable flight system of claim 28, wherein the right rotational joint and left rotational joint each further comprise a biasing member for biasing the portion with lower stiffness into the rigid sleeve.

32. The wearable flight system of claim 28, wherein the resilient member with at least two portions of differing stiffnesses comprises:
two resilient members with differing stiffnesses attached to each other; and/or
a single resilient member with varying stiffness along its length.

33. (canceled)
